(19) United States
(12) Patent Application Publication
(10) Pub. No.: US 2006/0136391 A1
(43) Pub. Date: Jun. 22, 2006

(54) System and method for generating a search index and executing a context-sensitive search

(76) Inventor: Robert P. Morris, Raleigh, NC (US)

Correspondence Address: IPAC, 111 Corning Road, Suite 220, Cary, NC, 27511, US

(21) Appl. No.: 11/022,133

(22) Filed: Dec. 21, 2004

(51) Int. Cl. G06F 17/30

(52) U.S. Cl. 707/3

(57) ABSTRACT

A system and method for generating a search index and executing a context-sensitive search are described. An exemplary method includes receiving an object in a browser that is included in a client device. Information available to the browser that is associated with the received object is determined. A search index for the object is created in the client device using the information available to the browser. The search index is transmitted from the client device.

### FIELD OF THE INVENTION

The present invention relates to search engines, and more particularly to a system and method for generating a search index and executing a context-sensitive search.

### BACKGROUND OF THE INVENTION

One problem with search engine technology is in retrieving relevant information with them. Creating the right search parameters is typically the key to finding the right data over the Internet. The World Wide Web (Web) is indexed by Bots, for example, that are automated programs that gather statistics or index content and build databases. Companies like GOOGLE use Bots to find web pages. After a user enters a search query into a search engine, information in the databases built with a Bot are ranked according to some method such as counting the number of links to a page, or the number of hits to a page, and the results returned to the user.

One problem with this approach is that islands of information are unavailable. An island on the Web is a web page or pages that have no links from the outside, i.e., they are more or less isolated from the Web as a whole. Because there are no links to these sites from the outside, a Bot cannot find these islands of information, and therefore cannot index them in a database available for searching. Also, some site providers prohibit Bots because they consume bandwidth that the site must pay for and are generally intrusive.

Another problem with the conventional approach is that context information is unavailable regarding the search query. The user has no ability in a search for the term “panther” to specify text files having the word, web pages that contain graphic files with pictures of the animal, or web pages containing links to audio files by a music group called “Panther”.

A further problem with the conventional approach is that much content on the web is generated dynamically, typically requiring some input from the user. Bots cannot access this content. This dynamically generated content and islands of information have been referred to as the “dark web” and are considered unsearchable.

Accordingly, what is needed is a system and method for generating a search index and executing a context-sensitive search. The present invention addresses such a need.

### BRIEF SUMMARY OF THE INVENTION

The present invention provides a system and method for generating a search index and executing a context-sensitive search. An exemplary system for executing a context-sensitive search in a server includes a network connection configured to receive a search criteria. A processor is coupled to the network connection and is configured to retrieve an object having associated context information that matches the search criteria, wherein the associated context information is not inherent to the object. The server then transmits an identifier of the object.

According to a method and system disclosed herein, the present invention provides a method and system of generating a search index, executing a context-sensitive search, and ranking the results. A user of a client device may generate a search index by browsing the Web. Objects, including web pages, music, text and graphic files, etc., may be received through the browser. The object may be parsed for content information, such as song titles and picture headings, and context information. An index for that object may be created and stored, either in the client device or in a server.

At some point in time, the user may wish to execute a context-sensitive search. The user may generate a context-sensitive search by sending search criteria to a server. The server receives the search criteria that typically includes one or more keywords that, in the case of a context-sensitive search, may include context information.

The server may then search its databases or indexes for one or more objects that match the search criteria. The results of the search (identifiers of the one or more matching objects and/or the objects themselves) may then be transmitted to the user.

To rank the results of the search, the server, prior to transmission to the user, may receive ranking criteria from the user or apply customized ranking criteria to the search results.

### BRIEF DESCRIPTION OF SEVERAL VIEWS OF THE DRAWINGS

FIG. 1 is a block diagram illustrating one embodiment of a system for executing a context-sensitive search.

FIG. 2 is a flow diagram illustrating one method of generating a search index with the client device of FIG. 1.

FIG. 3 is a block diagram illustrating one example of context-sensitive search criteria applied to the system of FIG. 1.

FIG. 4 is a flow diagram illustrating one method of executing a context-sensitive search with the system of FIG. 1.

FIG. 5 is a flow diagram illustrating one method of ranking search results with the system of FIG. 1.

### DETAILED DESCRIPTION OF THE INVENTION

The present invention relates to search engines, and more particularly to a system and method for generating a search index and executing a context-sensitive search. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

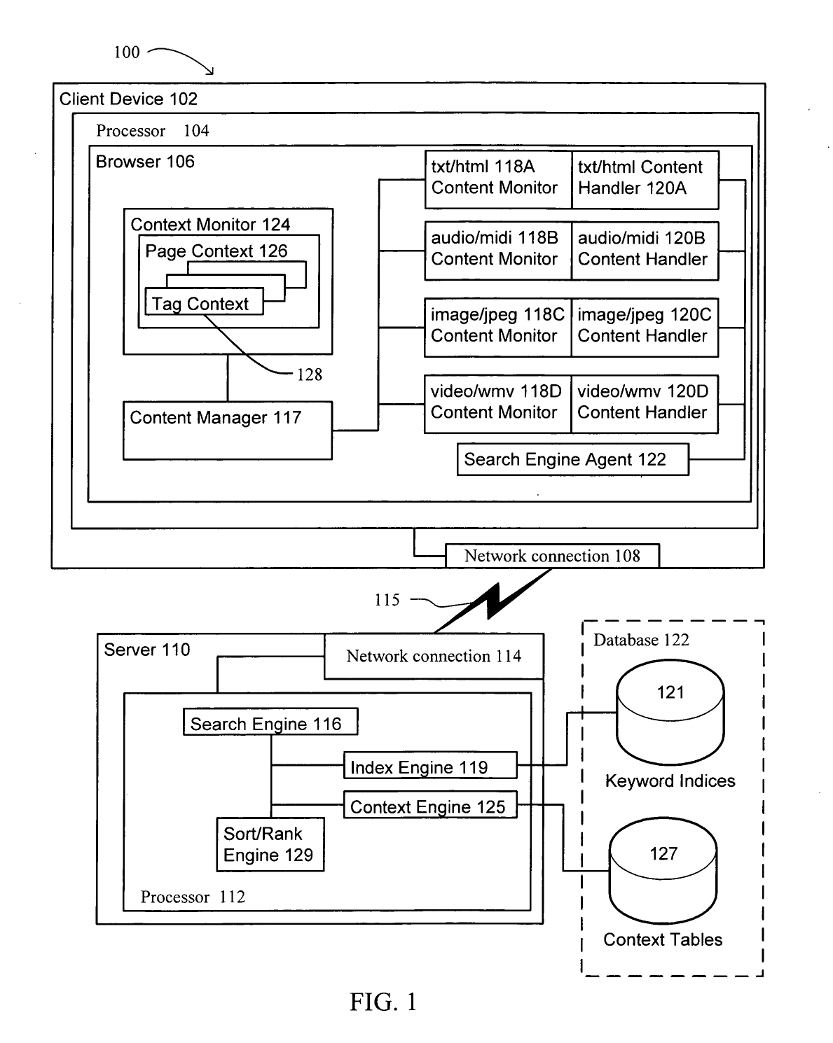

FIG. 1 is a block diagram illustrating one embodiment of a system 100 for executing a context-sensitive search. The system 100 includes a client device 102 and a server 110. A client device 102 may include, for example, a personal computer (PC), a personal digital assistant (PDA), notebook, or any other device with a processor 104 running a network browser 106 (for example, MICROSOFT EXPLORER and MOZILLA) and a network connection 108. The server 110 is typically a workstation, but includes any computer or system with a processor 112 and a network connection 114.

In one embodiment of the invention, a user of client device 102 may generate a search index by browsing the Web, for example, using browser 106. Objects, including web pages, music, text and graphic files, etc. may be received through the browser 106, whether the objects are viewed, interacted with, or downloaded, for example. The object or related objects may be parsed for both content information and context information. As used here, content information includes information that is inherent to (or is directly related to) the object itself, and can include information such as the type (e.g., ADOBE PDF, MICROSOFT VISIO, JPEG, or HTML), name, title, author, creation date, and subject of the object, and metadata associated with the object.

Context information, includes information that is not inherent to (or is secondary, additional or peripheral to) the object. Examples of context information include objects received in the browser 106 before or after the object is received, attributes of other objects arranged near the received object in the browser 106, attributes of mark-up language tags that include the object, attributes of links to additional metadata associated with the object, attributes of a user of the browser 106, such as interests and other non-personal information, identifiers of other objects linked to the received object, and information indicating that the object's content information comes from a title or heading in the browser 106. An index for the object is created in the client device 102 indexing the content and/or context information, and can either be stored in the client device 102 or transferred to server 110.

Client device 102 includes a processor 104 that may be running a browser 106. In one embodiment of the invention, browser 106 includes a content manager 117 interfacing with one or more content monitors 118A, 118B, 118C, and 118D, which in turn interface with one or more content handlers 120A, 120B, 120C, and 120D. Also interfaced to the content monitors 118 is a search engine agent 122. A context monitor 124 receives data from the content manager 117. The context monitor 124 develops a page context 126, using its knowledge of page format and structure to discover context concerning the objects embedded in or referred to by the page. For example, each tag in an HTML page contains context information 128 about its contents and the data arranged or received in the browser 106 before and after it.

Whether or not a user of client device 102 generates a search index, in another embodiment of the invention, the user may generate a context-sensitive search by sending search criteria to the server 110 over a network 115, such as the Internet. The server 110 receives the search criteria through a network connection 114. The search criteria typically includes one or more keywords that, in the case of a context-sensitive search, may include context information. Examples of context information are presented above.

The server 110 may then search its databases or indexes (which may be located on the client device 102) for one or more objects that match the search criteria. The results of the search (identifiers of the one or more matching objects and/or the objects themselves) may then be transmitted to the user through the client device 102.

Server 110 may include a processor 112 running a search engine 116 and interfacing an index engine 119, a context engine 125, and a sort/rank engine 129. The server 110 may include a database 122, or the database 122 may be external to the server 110, or located in the client device 102. Database 122 includes keyword indices 121 and context tables 127.

To rank the results of the search, in another embodiment of the invention, the server 110, prior to transmission to the user, may receive ranking criteria from the user or apply customized ranking criteria to the search results. Examples of ranking criteria may include the number of accesses to each object by users with certain criteria (for example, by users living in California, or users who love music, or users who download predominantly JPEG files), or the number of users having accessed the object in the past (which may be different from the number of links to a site with the keyword), and so on. Ranking is typically done by the server 110, but may be done by the client device 102.

In one application of the invention, consider the following example. Joe Audio loves jazz music. He and some others create a web site where they write articles and reviews about the music they love. The site has reviews, history, forums, and so on, but no links from outside websites. Some of the information is in a database, so page content is generated as required.

Joe's client device 102 has a search engine agent 122 to which Joe has provided information about his interests, but not personal information such as his name and address. As Joe visits the pages of his website, the search engine agent 122 detects the pages and objects in his website, and catalogs them and creates an index of them. It may catalog metadata such as the author, creation date, subject, keywords, or it may track browsing history, such as where Joe was before each page and where he went afterwards, or whether a page was reached through a link or through typing in the Uniform Resource Locator (URL) in the address bar of the browser 106. The catalog and index may be sent to server 110.

Continuing with the above example, Ann also loves jazz music but does not know about Joe's site. Because Joe's site does not have links from other websites, Ann would not be able to locate it with conventional search engines. However, Ann wants to find a song entitled “I've got them lo'down weekend blues.”

Server 110 could find Joe's site because it has access to the information provided by Joe's browser 106. Since Ann was browsing online music prior to entering the song title as the search term, the server 110 could prioritize music titles or jazz music. Additionally, because Ann and Joe have the same interests, the server 110 could prioritize sites Joe had also visited. The context information regarding Ann's recent activity and her interests is tracked by content monitors (118) and the context monitor 124 in Ann's browser. Finally, server 110 would have access to all the song titles (context information) in Joe's site, and make that available to Ann from a search.

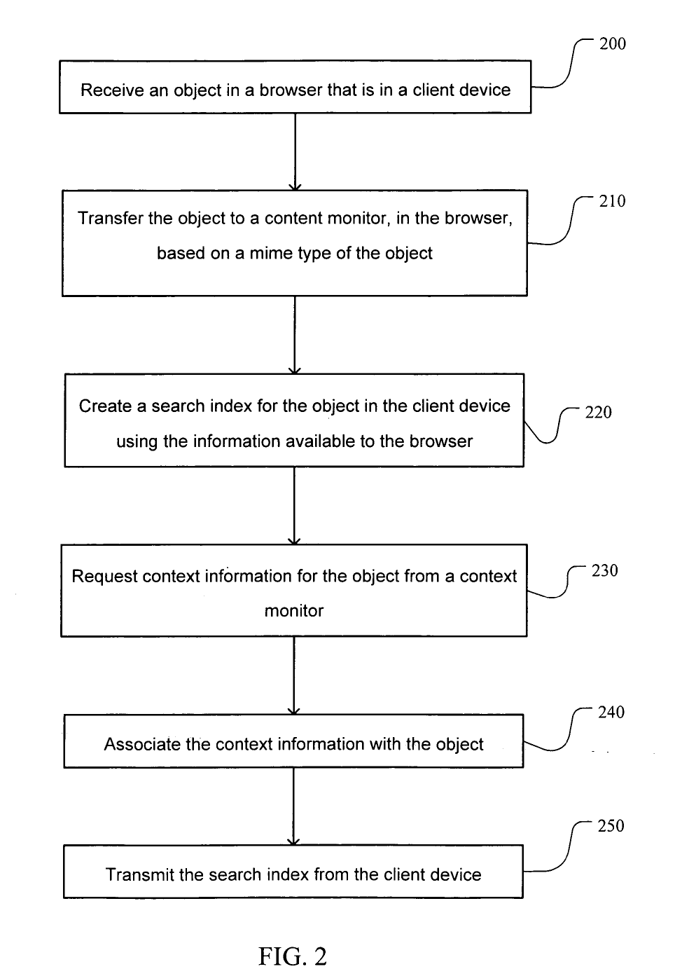

FIG. 2 is a flow diagram illustrating one method of generating a search index with the client device of FIG. 1. FIG. 2 will be discussed in conjunction with FIG. 1. The reference numerals from 100 up to 200 denote portions of FIG. 1 while the reference numerals from 200 up to 300 denote portions of FIG. 2, and so on with respect to the remaining figures.

In block 200, a user of the client device 102 receives an object in the browser 106 through the network connection 108 to the network 115. As used here, an object includes data available from the Web that can be accessed through a browser 106. In the broadest sense, an object can include any portion of such data that can addressed using an URL, such as a web site, a web page, a portion of a web page, a downloaded file, an image, streaming content, and the like.

Once the object is received, then in block 210 a content manager 117 determines the data type, for example a mime type, of the object. Once the mime type is determined, the content manager 117 transfers the object to an appropriate content monitor, such as a content monitor for text 118A, a content monitor for audio 118B, a content monitor for images 118C, or a content monitor for video 118D, for example. The content monitors will be generally discussed with respect to reference numeral 118. Content monitors 118 intercept content for each mime type and process the content prior to passing the content to the content handlers 120 for further processing and presentation. Content monitors 118 may process an object for data and metadata. The specific content monitor 118 to which the object is passed depends upon the mime type of the object. For example, if the object's mime type is Hyper-Text Mark-up Language (HTML), then the object goes to the content monitor for text 118A. If the object is in MIDI format, then the object goes to the content monitor for audio 118B. If the object is in JPEG format, then the object goes to the content monitor for audio 118C. If the object is in WMV format, then the object goes to content monitor for video 118D. Many different content monitors 118 may be available to browser 106; the examples provided are not limiting or defining. The content monitors 118 may provide indexed data and metadata to the search engine agent 122, but need not provide structural or contextual information.

After processing the content, the content monitors 118 may route the object to an appropriate content handler, such as a content handler for text 120A, a content handler for audio 120B, a content handler for images 120C, or a content handler for video 120D, for example, depending on the mime type. The content handlers will be generally discussed with respect to reference numeral 120. Content handlers understand the structure of the types they support and are thus able to parse and present the data when requested by the browser.

In an alternate embodiment, a single content monitor 118 and a single content handler 120 may be provided that processes multiple mime types.

Next, in block 220, one of the content monitors 118 creates a search index for the object. The index is created using information available to the browser, for example by processing content from the object and any embedded metadata. Creating indices from text documents is well-known and is done by most web search engines. For other object types, such as images, indices are created using metadata found in the object and metadata associated with the object such as it's name and it's source.

Next, in block 230, one of the content monitors 118 requests context information about the object from the context monitor 124. The context information can include the types of relationships that exist between different parts of a page, for example. The context monitor 124 may include a page context 126 that may contain key words in the page at or near some object, for example an image. The page context 126 may include tag context 128 that includes key words in the tags containing an object, such as an image or an audio file. Tags may include the title of a song or a picture, the name of an electronic book, alternate display text, and so on. Page context 126 may include metadata, such as creator, creation date, subject, copyright information, or any of the other types of context information described above. For example, a request to the context monitor 124 for context information concerning an image in a web page may return the hierarchy of headings for each section of the web page the image is contained in, keywords from the text in the paragraphs surrounding the image, HTML tag and attributes that referenced the image, whether the image is a link, and what it links to, keywords for the page or object that the image is linked to, etc. Recall from above that the context data is not discoverable directly in each data object that it relates to. That is, it is not inherent in each data object. Instead, the context information can be discoverable through the relationships among the various data objects included in the page or object where the data objects reside.

Each data object is associated with a different format, for example ADOBE PDF, MICROSOFT VISIO, JPEG, or HTML. Each format may be supported by a context plug-in (not shown) to the context monitor 124 to parse the context information from an object written in that format. The context monitor 124 matches data from the content monitor 118 with the appropriate plug-in to obtain the context information.

After the context monitor 124 has obtained the context information from the object, the context monitor 124 transmits the context data back to the content monitor where, in block 240, one of the content monitors 118 associates the context information with the object.

Then, in block 250, one of the content monitors 118 requests the search engine agent 122 to transmit the search index to the server 110 for processing. The context information and the index assist with context-sensitive searching. Each of the context information and the index can be associated with the object separately. In another embodiment, the index and context information may be stored in the database 122 that is on the client device 102.

In another embodiment, search engine agent 122 may receive user characteristics from the user of the client device 102. User characteristics may include Web browsing habits/history, likes, dislikes, geographic location, or whatever information a user wants to and is comfortable with making public. These are other examples of context information not inherent in the objects that the information is related to.

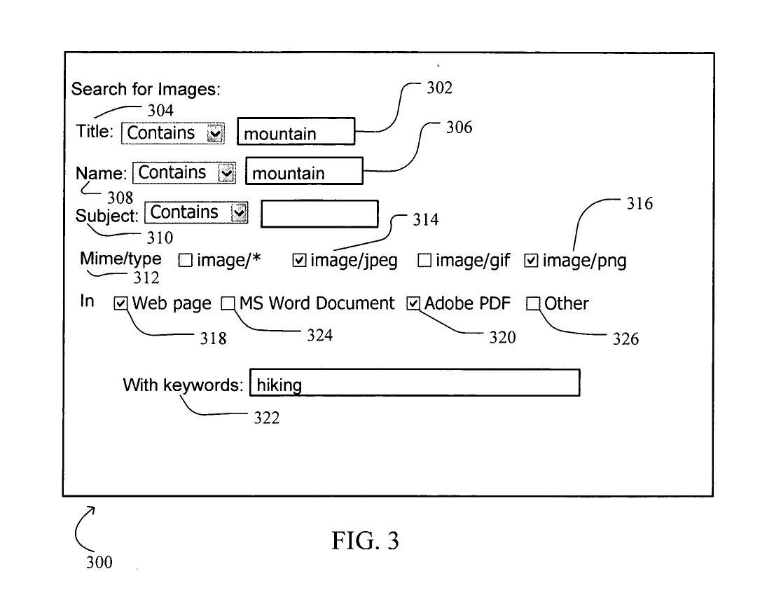

At some point in time, a user may desire to perform a context-sensitive search. FIG. 3 is a block diagram illustrating one example of context-sensitive search criteria applied to the system of FIG. 1. FIG. 3 will be discussed in conjunction with FIG. 1. Image 300 is one example of a screen shot showing a user interface for performing a context-sensitive search for an image (or picture). For example, assume that a user of the client device 102 desires to perform a context-sensitive search for an image of a mountain depicting hikers. Assume for this example that the client device 102 is a personal computer and that the image 300 is generated by the browser 106 and displayed on a monitor (not shown). The user might fill out fields in the user interface shown in the image 300 in the following manner.

Because the user is looking for an image of a mountain, the user might put “mountain” 302 under the title 304 criteria. Also, the user could put “mountain” 306 under the name 308 criteria. To broaden the search, the user decides, in this example, to leave the subject 310 open. For the mime type 312 the user wants the results in either JPEG 314 or PNG 316 format, and the user indicates that the image might be found in a web page 318 or an ADOBE PDF file 320, but not in a word document. The user may input the word “hiking” as a keyword 322.

In contrast to conventional systems, the user is able to input context-sensitive information, that is, information that is associated with but not inherent to the objects being searched, rather than only keywords, into the search. In addition, the title 304 and the name 308 indicate where the word “mountain” should appear. Also, the mime type 312 of the desired document (the image) may be specified, which in this example is limited to an image, and can be used to determine the range of context information searched. Also, where the image should be located, whether a web page 318, WORD document 324, ADOBE PDF 320, or some other place 326, may be specified. Because the underlying search engine index includes entries for both content and context information associated with an object of interest, the information entered into the user interface 300 can return more robust search results. One of ordinary skill in the art will recognize that the invention includes more and different combinations of context-sensitive searches.

After entering the details for the context-sensitive search into the user interface shown in image 300, assume the user sends the search criteria to server 110.

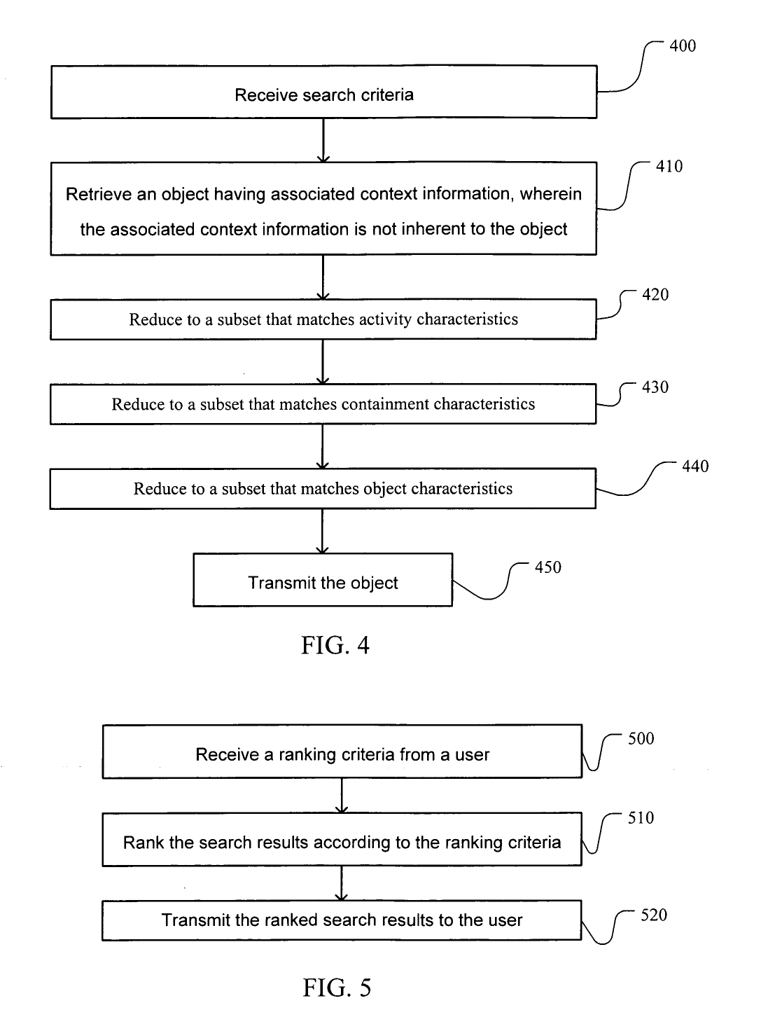

FIG. 4 is a flow diagram illustrating one method of executing a context-sensitive search with the system of FIG. 1. FIG. 4 will be discussed in conjunction with FIG. 1 and FIG. 3. In block 400, the server 110 receives search criteria, including a keyword and context information, for example the criteria in the user interface shown in the image 300. The server 110 may receive the search criteria through the network connection 114, where the search criteria is routed to processor 112, for example. Search engine 116 may be an enhanced search engine for context-sensitive searching in addition to keyword searches.

Search engine 116 may parse keywords from the search criteria and send the keywords to the index engine 119. The index engine 119 may search the keyword indices 121 for matching keywords and objects relating to those keywords. The keyword indices 121 may be located in the database 122, which may be remotely located or a part of the server 110.

The search engine 116 may parse out context information from the search criteria and send the context information to the context engine 125. The context engine 125 maintains context records for each vocabulary and supports searches of the context tables 127 and relationships. The context tables 127 may be located in the database 122.

For example, with respect to the user interface shown in the image 300, the search engine 116 may receive search criteria with a keyword 322 for “hiking”, looking for all images of type PNG or JPEG that have a matching keyword in their associated indices. Next the results are passed to the context engine 125 requesting that the results be reduced to those that appear in or are in some other way associated with a web page 318 or ADOBE PDF 320 file (such as through link). Further, the context engine can reduce the result set further to return only those images where the word “mountain” in the Title 304 and in the Name 308.

After searching the keyword indices 121 and the context tables 127, in block 410, the index engine 119 and the context engine 125 retrieve objects that have associated context information. Again, note that the context information is not inherent to the object. That is, the context information is not contained in or derivable directly from the object itself. For example, image size is information about the image that is inherent in the image object. Keywords in the paragraph in a web page which the image appeared in is context information that is not inherent in the image, but is discovered through the structure of the web page and it's relationship to the image object.

The retrieved objects may be reduced to a subset that matches activity characteristics, in block 420. As mentioned previously, activity characteristics relate to the activities of the user and may be used as context for defining search results. Examples include the web sites the user has recently visited, patterns of browsing activity, user preferences discerned from past activity, or information the user provides, etc. Continuing with the above example, the user may enjoy backpacking so the subset of the retrieved objects may be backpacking related images of hiking in the mountains. The user may decide to reduce the retrieved object set, or the server 110 may reduce the set.

Then, in block 430, the retrieved objects may be reduced to a subset that matches containment characteristics. Containment characteristics may include whether the object is, or is in, a web page, a WORD document, a PDF file, and so on.

Then in block 440, the retrieved objects may be reduced to a subset that matches object characteristics. Object characteristics include mime types, for example. Blocks 420, 430, and 450 are optional, may be executed automatically, or at the request of the user. They may be executed one at a time, in any order, or simultaneously.

Then, in block 450, the server 110 may transmit the retrieved results (identifiers of the retrieved objects and/or the objects themselves) to the client device 102. Note the order of the steps in FIG. 4 are just an example of how search criteria can be applied.

Other examples of search criteria may include a characteristic of a user that was previously associated with the object. For example, the author of an image resulting from the search criteria of FIG. 3 may have listed “traveling” as a hobby on an online profile, or may live in the Pacific Northwest.

Results from search engine 116 may also be combined with information discovered through conventional Web Bots.

To facilitate a user finding an object for which he/she is looking, the server 110 may sort or rank objects found with the sort/rank engine 129 prior to transmitting in block 420.

FIG. 5 is a flow diagram illustrating one method of ranking search results with the system of FIG. 1. FIG. 5 will be discussed in conjunction with FIG. 1. In block 500, server 110 receives ranking criteria from a user of client device 102. One example of ranking criteria is the number of accesses to search results (for example, search results from block 410, though one of ordinary skill in art will recognize that the method of ranking search results may apply strictly to keyword searches) by users who meet a certain criteria. Criteria for users may include users whose hobbies include photography or pottery, for example, or users who live in Canada, or users who frequent web sites for online books or some other browsing history.

Another example of ranking criteria may include the number of accesses by users to the search results regardless of the characteristics of the users. Conventional systems rank according to the number of links to a site, however, other, less publicized sites may contain more pertinent information for a given context/keyword search, and should therefore be ranked higher in a search.

Another example of ranking criteria is a comparison between a user's profile and the profiles of other users who have previously accessed the search results. Any definable and recordable criteria for a user may be applied to the sort/rank engine 129, whether browsing history, location, gender, place of work, and so on. The only limit could be the user's own comfort with providing or making available their information. The user could control how much or what information is made available.

Another example of ranking criteria is the number of accesses by users resulting from a matching activity, for example users who enter search criteria after visiting a travel site, having just visited a travel site as the matching activity.

After receiving the ranking criteria in block 500, then in block 510 the server 110 ranks the search results according to the ranking criteria. Finally, in block 520, the server 110 transmits the ranked search results to the user.

One advantage of the invention is that activity data may be gathered from dynamic and secure pages like shopping pages. A user's past behavior may be applied to customize search results, as well as a user's profile.

According to the method and system disclosed herein, the present invention provides a system and method for generating a search index and executing a context-sensitive search. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

1. A method for generating a search index comprising:
receiving an object in a browser that is included in a client device;
determining information available to the browser that is associated with the received object
creating a search index for the object in the client device using the information available to the browser; and
transmitting the search index from the client device.

2. The method of claim 1 further comprising:
determining content information inherent to the object based on a type of the object; and
including the content information in the search index for the object.

3. The method of claim 2 further comprising:
including as content information in the search index at least one of the type, a name, an author, a creation date, a subject, and metadata associated with the object.

4. The method of claim 1 further comprising:
determining context information associated with but not inherent to the object; and
including the context information in the search index for the object.

5. The method of claim 4 further comprising:
including as context information in the search index at least one of objects received in the browser before or after the object is received, attributes of other objects arranged near the received object in the browser, attributes of mark-up language tags that include the object, attributes of links to additional metadata associated with the object, attributes of a user of the browser, and identifiers of other objects linked to the received object.

6. The method of claim 4 further comprising:
transmitting the received object from the client device along with the search index.

7. The method of claim 2, wherein receiving an object in a browser further comprises:
receiving a data stream that includes the object; and
determining the content information based on a type of the data stream.

8. A method for executing a context-sensitive search comprising:
receiving search criteria in a server;
retrieving an object having associated context information that matches the search criteria, wherein the associated context information is not inherent to the object; and
transmitting an identifier of the retrieved object from the server.

9. The method of claim 8, the context information comprising a characteristic of a user.

10. The method of claim 8, the context information including a characteristic of an activity of a user that was previously associated with the object.

11. The method of claim 8, wherein retrieving an object further comprises:
processing the search criteria in the server to identify content information and context information that match the search criteria; and
generating the object for the search request based on the context information and the content information that match the search criteria.

12. The method of claim 8 further comprising:
counting a number of accesses to the search results by users who meet a set of criteria;
ranking the search results based on the number of accesses to the search results by users who meet the set of criteria, wherein the number of accesses to the search results by users who meet the set of criteria is the ranking criteria; and
transmitting the ranked search results to the user.

13. The method of 12, wherein the set of criteria comprises a browsing history.

14. The method of 12, wherein ranking the search results further comprises:
counting a number of accesses by users to the search results; and
ranking the search results based on the number of accesses to the search results by users, wherein the number of accesses to the search results by users is the ranking criteria.

15. The method of 12, wherein ranking the search results further comprises:
comparing a user's profile to profiles of other users who have accessed the search results; and
ranking the search results based on a similarity between the user's profile and the profiles of other users who have accessed the search results, wherein the user's profile is the ranking criteria.

16. The method of claim 12, the set of criteria being an empty set wherein the search results are ranked based on the number of accesses to the search results by users.

17. A computer-readable medium containing programming instructions for generating a search index, the programming instructions comprising:
receiving an object in a browser that is included in a client device;
determining information available to the browser that is associated with the received object
creating a search index for the object in the client device using the information available to the browser; and
transmitting the search index from the client device.

18. The computer-readable medium of claim 17, the instructions further comprising:
determining content information inherent to the object based on a type of the object; and
including the content information in the search index for the object.

19. The computer-readable medium of claim 18, the instructions further comprising:
including as content information in the search index at least one of the type, a name, an author, a creation date, a subject, and metadata associated with the object.

20. The computer-readable medium of claim 17, the instructions further comprising:
determining context information associated with but not inherent to the object; and
including the context information in the search index for the object.

21. The computer-readable medium of claim 20, the instructions further comprising:
including as context information in the search index at least one of objects received in the browser before or after the object is received, attributes of other objects arranged near the received object in the browser, attributes of mark-up language tags that include the object, attributes of links to additional metadata associated with the object, attributes of a user of the browser, and identifiers of other objects linked to the received object.

22. The computer-readable medium of claim 20, the instructions further comprising:
transmitting the received object from the client device along with the search index.

23. The computer-readable medium of claim 18, wherein receiving an object in a browser further comprises:
receiving a data stream that includes the object; and
determining the content information based on a type of the data stream.

24. A system for executing a context-sensitive search in a server comprising:
a network connection configured to receive a search criteria; and
a processor coupled to the network connection and configured to retrieve an object having associated context information that matches the search criteria, wherein the associated context information is not inherent to the object, and the network connection is further configured to transmit an identifier of the object from the server.

25. The system of claim 24, the context information comprising a characteristic of a user.

26. The system of claim 24, the context information including a characteristic of an activity of a user that was previously associated with the object.

27. The system of claim 24, the processor further configured to operate a search engine, the search engine configured to process the search criteria for content information and context information, to generate the object for the search criteria based on the context information and the content information.

28. The system of claim 24 the processor further configured to maintain a sort/rank engine and to receive a ranking criteria, the sort/rank engine configured to count a number of accesses to the search results by users who meet a set of criteria, and to rank the search results based on the number of accesses to the search results by users who meet the set of criteria, wherein the number of accesses to the search results by users who meet the set of criteria is the ranking criteria, and to transmit the ranked search results to the user.

29. The system of claim 28, wherein the set of criteria comprises a browsing history.

30. The system of 28, the processor further configured to count a number of accesses by users to the search results, and to rank the search results based on the number of accesses to the search results by users, wherein the number of accesses to the search results by users is the ranking criteria.

31. The system of 28, the processor further configured to compare a user's profile to profiles of other users who have accessed the search results, and to rank the search results based on similarity between the user's profile and the profiles of other users who have accessed the search results, wherein the user's profile is the ranking criteria.

32. A system for generating a search index in a client device comprising:
a network connection configured to receive an object;
a processor configured to maintain a browser, a content manager, a content monitor, and a search engine agent, the content manager configured to determine information available to the browser that is associated with the received object, the content monitor configured to create a search index for the object in the client device using the information available to the browser, and the search engine agent configured to transmit the search index from the client device.

33. The system of claim 32, the content monitor further configured to determine content information inherent to the object based on a type of the object, and for the search engine agent to include the content information in the search index for the object.

34. The system of claim 33, the content handler further configured to include as content information in the search index at least one of the type, a name, an author, a creation date, a subject, and metadata associated with the object.

35. The system of claim 32, the processor further configured to maintain a context monitor, the context monitor configured to determine context information associated with but not inherent to the object, and for the search engine agent to include the context information in the search index for the object.

36. The system of claim 35, the context monitor further configured to include as context information in the search index at least one of the objects received in the browser before or after the object is received, attributes of other objects arranged near the received object in the browser, attributes of mark-up language tags that include the object, attributes of links to additional metadata associated with the object, attributes of a user of the browser, and identifiers of other objects linked to the received object.

37. The system of claim 35, the search engine agent further configured to transmit the received object from the client device along with the search index.

38. The system of claim 33, the browser further configured to receive a data stream that includes the object, and for the content manager to determine the content information based on a type of the data stream.
